(19) United States
(12) Patent Application Publication
(10) Pub. No.: US 2025/0180830 A1
(43) Pub. Date: Jun. 5, 2025

(54) CONNECTOR POSITION ASSURANCE DEVICES AND CONNECTOR SYSTEMS AND OPTICAL ASSEMBLIES INCORPORATING THE SAME

(71) Applicant: CORNING RESEARCH & DEVELOPMENT CORPORATION, Corning, NY (US)

(72) Inventors: Timothy Winston Anderson, Newton, NC (US); Thomas Theuerkorn, Hickory, NC (US)

(21) Appl. No.: 18/947,484

(22) Filed: Nov. 14, 2024

Related U.S. Application Data
(60) Provisional application No. 63/604,374, filed on Nov. 30, 2023.

(51) Int. Cl. G02B 6/38; H01R 13/627

(52) U.S. Cl. CPC G02B 6/389; H01R 13/6272

(57) ABSTRACT

In one embodiment, a connector position assurance (CPA) assembly includes a trigger housing operable to be disposed on a connector housing, the trigger housing including a retention arm, a CPA retention slot within a portion of the retention arm, a CPA stop at a forward end of the CPA retention slot, and a hood positioned above a portion of the CPA retention slot. The CPA assembly also includes a CPA device having a user actuation portion and a CPA arm, where a portion of the CPA arm is disposed within the CPA retention slot such that when the connector housing is not mated to a receptacle, forward motion of the CPA device is prevented by an end of the CPA arm contacting the CPA stop, and when the connector housing is mated to the receptacle, forward motion of the CPA device is permitted.

### PRIORITY APPLICATION

This application claims the benefit of priority of U.S. Provisional Application No. 63/604,374, filed on Nov. 30, 2023, the content of which is relied upon and incorporated herein by reference in its entirety.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent. Such communication networks demand the use of optical connectors, such as to connect drop cables to a terminal device. To prevent optical loss, an optical connector should be properly mated to a receptacle or other connector device. If there is a gap present between optical interfaces, or if there is a misaligning between optical channels of optical interfaces, signal degradation or failure may occur. As optical connectors become smaller and smaller, it may be difficult for a technician to know if a connection is made properly.

Accordingly, alternative connector assemblies that ensure a proper connection may be desired.

### SUMMARY

Embodiments of the present disclosure are directed to connector position assurance (CPA) devices and connector systems and optical systems incorporating the same. The CPA devices disclosed herein provide visual and haptic feedback that a connector assembly and a receptacle are properly mated to users. The CPA devices disclosed herein are low cost and reliable. Further, the CPA devices are operable to be provided in small-scale optical and/or electrical connectors.

In one embodiment, a connector position assurance (CPA) assembly includes a trigger housing operable to be disposed on a connector housing, the trigger housing including a retention arm, a CPA retention slot within a portion of the retention arm, a CPA stop at a forward end of the CPA retention slot, and a hood positioned above a portion of the CPA retention slot such that a gap region is present between the retention arm and the hood. The CPA assembly also includes a CPA device that includes a user actuation portion and a CPA arm extending from the user actuation portion, where a portion of the CPA arm is disposed within the CPA retention slot such that when the connector housing is not mated to a receptacle, forward motion of the CPA device is prevented by an end of the CPA arm contacting the CPA stop, and when the connector housing is mated to the receptacle, forward motion of the CPA device is permitted by deflection of the CPA arm into the gap region and above the CPA stop.

In another embodiment, a connector system includes a connector assembly and a receptacle. The connector assembly includes a connector housing and a connector position assurance (CPA) assembly. The CPA assembly includes a trigger housing and a CPA device. The trigger housing is disposed around the connector housing, and includes a retention arm, a CPA retention slot within a portion of the retention arm, a CPA stop at a forward end of the CPA retention slot, and a hood positioned above a portion of the CPA retention slot such that a gap region is present between the retention arm and the hood. The CPA device includes a user actuation portion and a CPA arm extending from the user actuation portion, where a portion of the CPA arm is disposed within the CPA retention slot. The receptacle is operable to receive the connector assembly and includes a receptacle latch stop, where when the connector housing is not mated to the receptacle, forward motion of the CPA device is prevented by an end of the CPA arm contacting the CPA stop. When the connector housing is mated to the receptacle, forward motion of the CPA device is permitted by deflection of the CPA arm into the gap region and above the CPA stop.

In another embodiment, an optical assembly comprises a cable assembly and a receptacle. The cable assembly comprises an optical cable comprising at least one optical fiber and a connector assembly. The connector assembly terminates the at least one optical fiber for forming the cable assembly. The connector assembly includes a connector housing and a connector position assurance (CPA) assembly. The CPA assembly includes a trigger housing and a CPA device. The trigger housing is disposed around the connector housing, and includes a retention arm, a CPA retention slot within a portion of the retention arm, a CPA stop at a forward end of the CPA retention slot, and a hood positioned above a portion of the CPA retention slot such that a gap region is present between the retention arm and the hood. The CPA device includes a user actuation portion and a CPA arm extending from the user actuation portion, where a portion of the CPA arm is disposed within the CPA retention slot. The receptacle is operable to receive the connector assembly and includes a receptacle latch stop, where when the connector housing is not mated to the receptacle, forward motion of the CPA device is prevented by an end of the CPA arm contacting the CPA stop. When the connector housing is mated to the receptacle, forward motion of the CPA device is permitted by deflection of the CPA arm into the gap region and above the CPA stop.

In another embodiment, a method of coupling a connector assembly to a receptacle includes inserting a connector housing of the connector assembly into the receptacle such that a receptacle latch stop is positioned within a CPA retention slot of a retention arm of a trigger housing, where the receptacle latch stop contacts a CPA stop of the retention arm, and a presence of the receptacle latch stop prevents a CPA arm of a CPA device from being present in the CPA retention slot. The method further includes pushing a user actuation portion of the CPA device in a direction toward the receptacle such that a portion of the CPA arm is disposed over the CPA stop to position the CPA device in an engaged state.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view of an example optical assembly with a CPA device in a disengaged state according to one or more embodiments described and illustrated herein.

FIG. 2 illustrates a perspective view of the optical assembly of FIG. 1 with the CPA device in the engaged state according to one or more embodiments described and illustrated herein.

FIG. 3 illustrates a perspective cutaway view of the optical assembly of FIG. 1 according to one or more embodiments described and illustrated herein.

FIG. 4 illustrates a cross-sectional view of the optical assembly of FIG. 1 with a connector assembly mated to a receptacle and the CPA device in a disengaged state according to one or more embodiments described and illustrated herein.

FIG. 5 illustrates the cross-sectional view of the optical assembly of FIG. 4 with the connector assembly mated to the receptacle and the CPA device in an engaged state according to one or more embodiments described and illustrated herein.

FIG. 6 illustrates a perspective view of another example optical assembly with a CPA device in a disengaged state according to one or more embodiments described and illustrated herein.

FIG. 7 illustrates a perspective view of the optical assembly of FIG. 6 with the CPA device in the engaged state according to one or more embodiments described and illustrated herein.

FIG. 8 illustrates an example CPA device according to one or more embodiments described and illustrated herein.

FIG. 9 illustrates a perspective view of an example trigger housing according to one or more embodiments described and illustrated herein.

FIG. 10 illustrates a cross-sectional view of a connector assembly not mated with a receptacle and a CPA device in two disengaged positions according to one or more embodiments described and illustrated herein.

FIG. 11 illustrates a cross-sectional view of the connector assembly of FIG. 10 mated with a receptacle and a CPA device in two disengaged positions according to one or more embodiments described and illustrated herein.

FIG. 12 illustrates a cross-sectional view of the connector assembly of FIG. 11 mated with a receptacle and a CPA device in a disengaged position and an engaged position according to one or more embodiments described and illustrated herein.

### DETAILED DESCRIPTION

Embodiments of the present disclosure are directed to CPA devices for use in small-scale connectors, such as optical connectors and/or electrical signal connectors. The CPA devices disclosed herein provide visual and/or haptic feedback that a connector assembly is properly mated to a receptacle or other component. Embodiments ensure that a connector assembly is fully latched at its connection point when it is seated with respect to a receptacle and prevents accidental latch release. The embodiments described herein only actuate into an engaged position when the primary connector latching mechanism is seated. In this way the CPA device provides feedback if the primary latch is not seated and prevents a false positive by seating when the connection is separated. The CPA devices described herein also prevent accidental detaching of a connector assembly to a receptacle.

Referring now to FIG. 1, an example optical assembly 102 is illustrated. The optical assembly 102 includes a receptacle 104 and a connector assembly 108. FIG. 1 illustrates the receptacle 104 and the connector assembly 108 in an unmated state. Although FIG. 1 illustrates an optical assembly, embodiments described herein may be utilized in receptacles and connectors providing electrical conductors, or hybrid optical and electrical conductors. It should also be understood that the receptacles and connector assemblies described herein are not limited to any type of receptacle and connector assembly and that different receptacle and connector types and configurations are contemplated.

The optical assembly 102 provides for the optical coupling a two fiber receptacle 104 and a two fiber connector assembly 108. However, a single fiber optical connection or a multi-fiber optical connection having more than two fibers may be provided.

The receptacle 104 may be port of an enclosure, a female connector of a connectorized optical cable, or other optical component desired to be mated with a connector assembly 108 of an optical cable assembly 156. The receptacle 104 defines a passageway 158 that is sized and shaped to securely receive a connector housing 142 of the connector assembly 108. The receptacle 104 includes a communication interface (not shown) within the passageway, such as optical elements (e.g., fiber ends) and/or conductors for making an optical and/or electrical connection with the connector assembly 108.

The receptacle 104 further includes a receptacle latch stop 106 that protrudes from a surface of the receptacle 104. The receptacle latch stop 106 includes a ramp 152 to deflect a retention arm 116 so that the receptacle latch stop is disposed within a CPA retention slot 118 the connector assembly 108 as described in more detail below. The receptacle latch stop 106 also includes a wall 154 that locks the connector assembly 108 to the receptacle 104 and prevents the connector assembly 108 from the receptacle 104 without first unlocking the connector assembly 108, as described in more detail below. Although only one receptacle latch stop 106 is shown, two or more may be provided.

The optical assembly 102 includes two optical cables 128 and a connector assembly 108. The connector assembly 108 generally includes a connector housing 142, a trigger housing 110, and a connector position assurance (CPA) device 112. The trigger housing 110 and the CPA device 112 define a CPA assembly 166 coupled to the connector housing 142.

The connector housing 142 may take on any shape and configuration. Although the connector housing 142 is illustrated as maintaining two ferrules, any number of ferrules may be provided, such as three, four or more ferrules. Further, the connector housing 142 may be configured to maintain a multi-fiber ferrule. The connector housing 142 is sized and shaped to securely be disposed within the passageway 158 of the receptacle 104. A communication interface, such as fiber ends within ferrules 134 (see FIG. 3) and/or electrical conductors, are within the a passageway 148 defined by the connector housing 142.

The trigger housing 110 is operable to be secured around the connector housing 142. As a non-limiting example, the trigger housing 110 may be secured to the connector housing 142 by a snap fit. However, other methods of securing the trigger housing 110 to the connector housing 142 may be utilized. In some embodiments, the connector housing 142 and the trigger housing 110 are a single, monolithic component.

The outer surface of the trigger housing 110 includes two protruding walls 160 with a hood 130 extending between the two walls 160 at a forward portion of the trigger housing 110. The walls 160 provide that the hood 130 is positioned in a plane above the connector housing 142 so that a gap region 144 is present (see FIG. 3) as described in more detail below.

The trigger housing 110 also includes a retention arm 116 that extends from an area under the hood 130 in a direction back toward the optical cables 128. The retention arm 116 may be pressed to unlock the connector assembly 108 from the receptacle 104 as described in more detail below. A portion of the retention arm 116 is exposed from the hood 130 to provide the user access to press the retention arm 116 down to unlock the connector assembly 108.

The retention arm 116 has a tapered section 146 such that it extends beneath the hood 130. The retention arm 116 further includes a CPA retention slot 118 in which a CPA device 112 is positioned. The CPA device 112 shown in FIG. 1 has a CPA protrusion 124 that is seated within the CPA retention slot 118. The CPA protrusion 124 provides a visual indication to the user as to the state of the CPA protrusion 124, which in turn provides a visual indication as to whether or not the connector assembly 108 is fully mated to the receptacle 104.

As described in more detail below, the retention arm 116 provides the dual functionality of locking the connector assembly 108 to the receptacle 104 and providing a stop for the CPA device 112. FIG. 1 illustrates the connector assembly 108 and the receptacle 104 in an unmated state. In this state, the CPA device 112 is in a disengaged state wherein it is pulled back such that a flange 126 of the CPA device 112 is offset from an end face 122 of the trigger housing 110 and the CPA protrusion 124 is in a backmost position (i.e., in a direction toward the optical cables 128) within the CPA retention slot 118. The user moves the CPA device 112 from a disengaged state to an engaged state by pushing on a user actuation portion 120 in a forward direction toward the receptacle 104. However, because the connector assembly 108 is not mated to the receptacle 104, the CPA device 112 is prevented from moving forward into the engaged state.

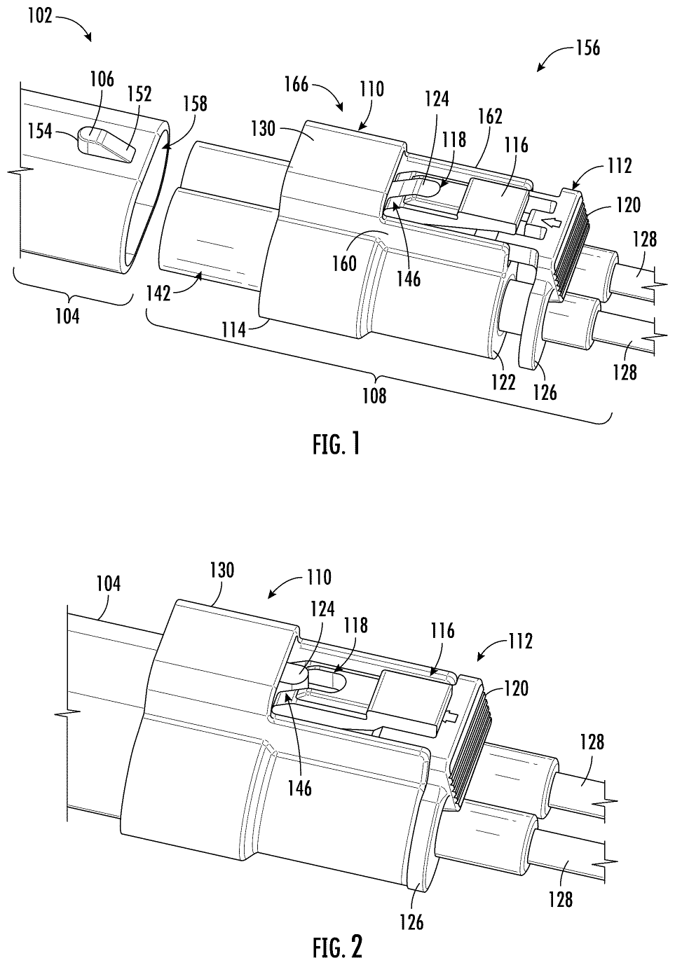

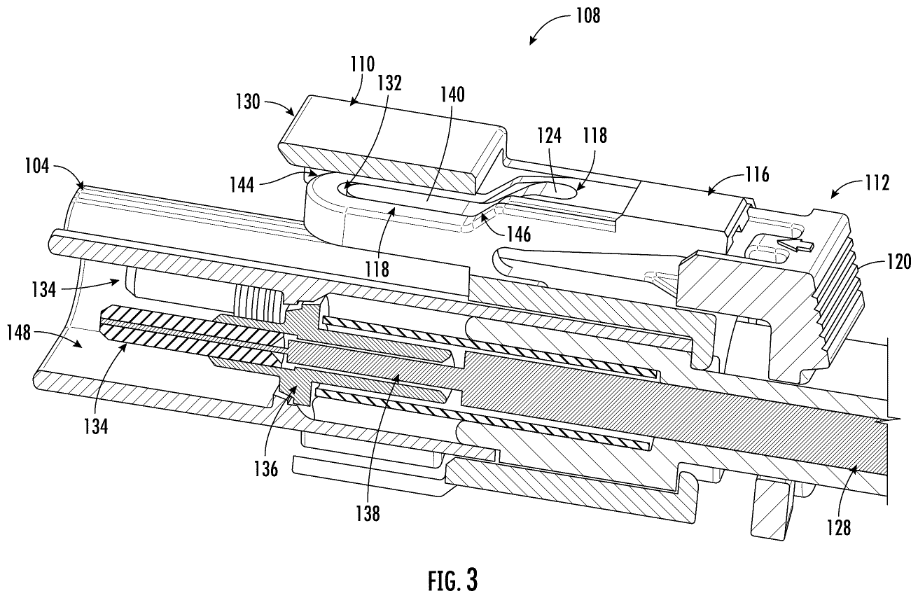

FIG. 2 illustrates the optical assembly 102 wherein the connector assembly 108 of the optical cable assembly 156 is mated to the receptacle 104. In this position, the user is able to push on the on the user actuation portion 120 of the CPA device to cause the CPA arm 140 to move forward in a direction toward the receptacle 104. In this engaged state, the CPA protrusion 124 is in its furthest forward position within the CPA retention slot 118 and the flange 126 of the CPA device 112 contacts the end face 122 of the trigger housing 110. The position of the CPA protrusion 124 within the CPA retention slot 118 provides a visual indication to the user that the connector assembly 108 is properly and securely mated to the receptacle 104. As described in more detail below, the CPA device 112 also prevents disengagement of the connector assembly 108 from the receptacle by inadvertent pressing down on the retention arm 116.

Referring now to FIG. 3, a cutaway view of an example connector assembly 108 in an unmated state is shown. The connector assembly 108 includes additional elements, such as ferrules 134 that receive optical fibers 138 and ferrule holders 136 that receive and maintain the ferrules 134. The retention arm 116 extends beneath the hood 130 after the tapered section 146. The CPA arm 140 is disposed within the CPA retention slot 118 that has a CPA stop 132 at its end. When the connector assembly 108 is not mated to a receptacle 104 as shown in FIG. 3, the CPA arm 140 is fully disposed within the CPA retention slot 118 and cannot move forward because it is prevented from movement by the CPA stop 132, which is defined by material at the end of the retention arm 116.

The hood 130 is offset from the upper surface of the retention arm 116 to define a gap region 144 therebetween. The gap region 144 provides a space for the retention arm 116 to reside when it is deflected upward upon mating between the connector assembly 108 and the receptacle 104.

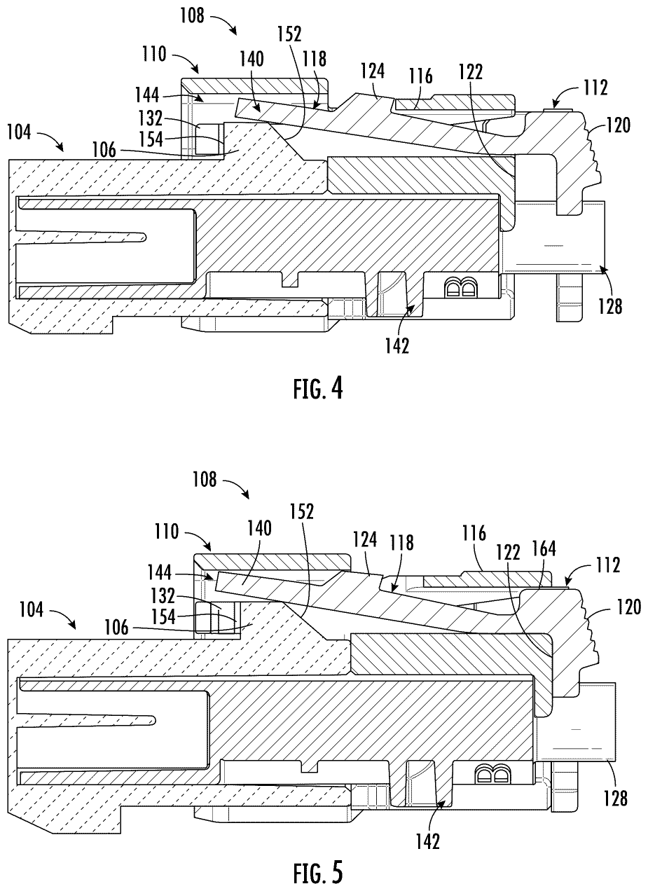

FIG. 4 illustrates the connector assembly 108 mated to the receptacle 104 but the CPA device being in the disengaged state. When the connector housing 142 is inserted into the receptacle 104, an upper portion of the receptacle 104 having the receptacle latch stop 106 is slid under the retention arm 116. The ramp 152 of the receptacle latch stop 106 pushes against the bottom surface of the retention arm 116 at the CPA stop 132 to deflect the retention arm 116 upward away from the receptacle 104 until the receptacle latch stop 106 clears the CPA stop 132 when the retention arm 116 snaps back to its original position. The wall 154 of the receptacle latch stop 106 prevents the connector assembly 108 from being pulled out of the receptacle 104.

The ramp 152 of the receptacle latch stop 106 also pushes against the CPA arm 140 so that it also is deflected away from the receptacle 104. When the receptacle latch stop 106 clears the CPA stop 132, it snaps back down. In this position, an end portion of the CPA arm 140 rests on the ramp 152 and is disposed within the gap region 144 between the retention arm 116 and the hood 130. The end of the CPA arm 140 is positioned above the CPA stop 132. This enables the CPA arm 140 to be pushed forward over the CPA stop 132.

FIG. 5 illustrates the connector assembly 108 mated to the receptacle 104 but the CPA device in the engaged state. In this state, the user has pushed on the user actuation portion 120 to slide the CPA device 112 in a direction toward the receptacle 104. This action moves the CPA arm 140 over an upper surface of the CPA stop 132 and also moves the CPA protrusion 124 forward within the CPA retention slot 118 to provide visual feedback to the user that the CPA device 112 is in the engaged state and thus the connector assembly 108 is properly mated to the receptacle 104.

When the CPA device 112 is in the engaged state, a nose portion 164 contacts a surface of the retention arm 116, which prevents the user from pushing down on the retention arm 116 to unlock the receptacle latch stop 106 from the CPA stop 132. Additionally, the CPA protrusion 124 prevents the retention arm 116 from being pushed downward due to contact with the hood 130.

To unlock the connector assembly 108 from the receptacle 104, the user pulls back on the CPA device 112, presses down on the retention arm 116, and then pulls the connector assembly 108 from the receptacle 104.

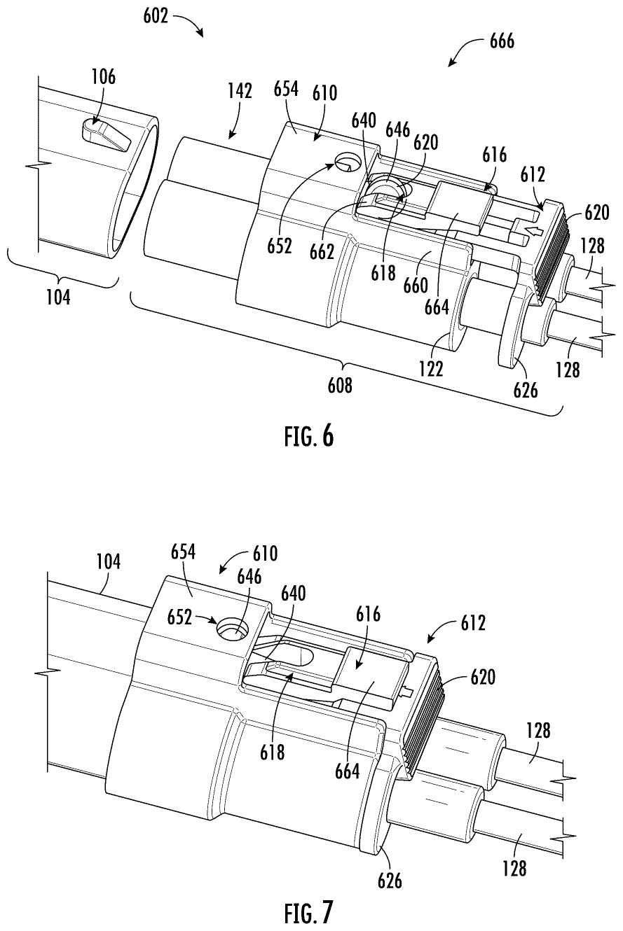

Referring now to FIG. 6, another example embodiment of an optical assembly 602 is illustrated. Like the optical assembly 102 shown in FIGS. 1 and 2, the optical assembly 602 shown in FIG. 6 includes a receptacle 104 and a connector assembly 608. The connector assembly 608 includes a connector housing 142, two optical cables 128, a trigger housing 610 and a CPA device 612, among other components. The trigger housing 110 and the CPA device 612 define a CPA assembly 666.

The trigger housing 610 is operable to be disposed around the connector housing 142 in a manner as described above with respect to the trigger housing 110 and the connector housing 142 shown in FIG. 1. The trigger housing 610 includes a retention arm 616 having a CPA retention slot 618, and two walls 660 coupled to a hood 654 such that the hood is in a plane offset from a surface of the retention arm. The retention arm 616 has a tapered section 662 such that it extends beneath the hood 654. Unlike the trigger housing 110 shown in FIG. 1 and FIG. 2, the hood 654 includes an arm receiving aperture 652 for receiving a portion of the CPA arm 640, as described below.

The CPA device 612 includes a CPA arm 640 that extends from a user actuation portion 620 and sits within a CPA retention slot 618. The CPA arm 640 includes a round portion 646 that resides in the CPA retention slot 618 when the CPA device 612 is in a disengaged state as shown in FIG. 6. The position of the round portion 646 in the CPA retention slot 618 gives the user visual feedback that the CPA device is in a disengaged state and the connector assembly 608 is not fully mated to the receptacle 104.

FIG. 7 illustrates the optical assembly 602 of FIG. 6 when the connector assembly 608 is inserted into the receptacle 604 and the CPA device 612 is pushed forward into the engaged state. In the engaged state the round portion 646 is disposed within the arm receiving aperture 652 and is visible to the user, which provides a visual indication to the user that the connector assembly 608 is properly mated to the receptacle 604 and the CPA device 612 is in the engaged state.

FIG. 8 illustrates an example CPA device 612 that may be used in the connector assembly 608. The CPA device 612 includes a CPA arm 640 that extends from a user actuation portion 620 and terminates at a hook end 648. A round portion 646 is positioned on the CPA arm 640 at a location between the user actuation portion 620 and the hook end 648. The CPA device 112 is made from a compliant material such that it may be deflected and returned to a nominal position between disengaged and engaged states.

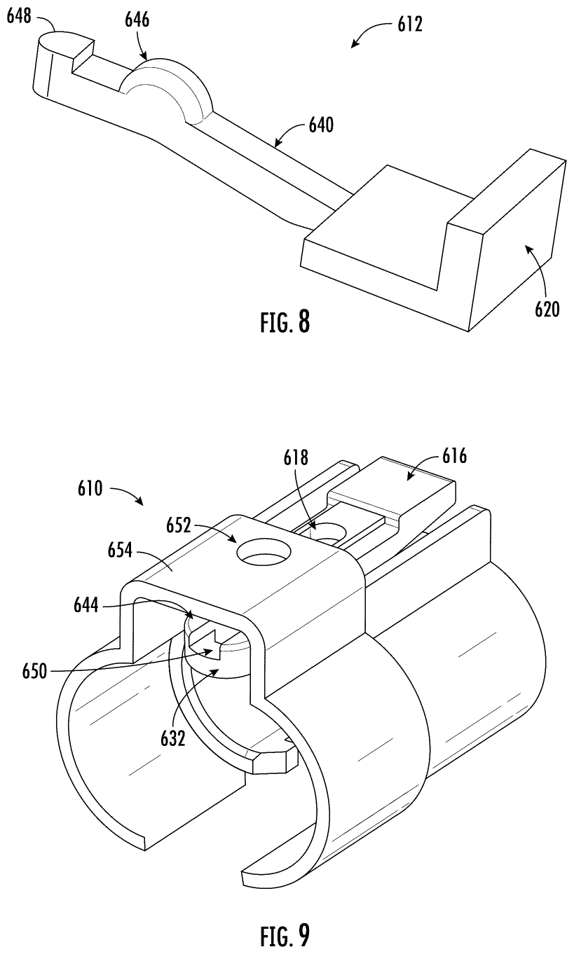

FIG. 9 is a perspective view of an example trigger housing 610. The retention arm 616 comprises a CPA retention slot 618 that extends from a user actuation end 664 to a CPA stop 632 similar to the retention arm 116 illustrated by FIG. 3. The CPA retention slot 618 is operable to receive a portion of the CPA arm 640. A gap region 644 is present between an upper surface of the retention arm 616 and a bottom surface of the hood 654. As described above with respect to the retention arm 116, the retention arm 616 shown in FIG. 9 is operable to be flexed upward by the ramp 656 of the receptacle latch stop 606 until the receptacle latch stop 606 clears the CPA stop 632. The wall 658 of the receptacle latch stop 606 abuts the CPA stop 632 thereby preventing the connector assembly 608 from being pulled out of the receptacle 604.

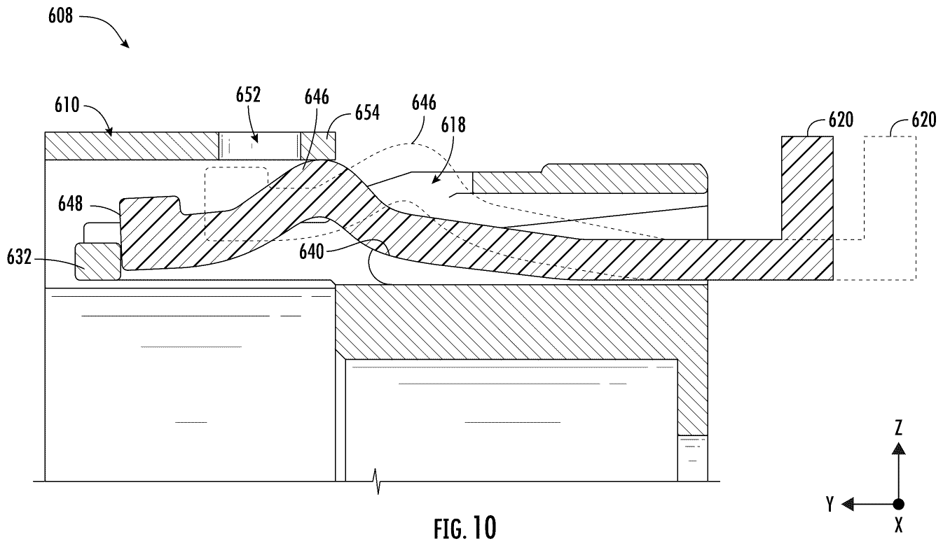

FIG. 10 illustrates the motion of the CPA device 612 when the connector assembly 608 is not mated to a receptacle 104 and how the CPA device 612 cannot be transitioned from a disengaged state to an engaged state without mating between the connector assembly 608 and the receptacle. The dashed lines represent the CPA device 612 prior to an attempt to push the CPA device 612 forward without the connector assembly 608 being mated to a receptacle 604. In this position, the round portion 646 is exposed from the hood 654 and visible within the CPA retention slot 618. The portion of the CPA arm 640 after the round portion 646 toward the hook end 648 is positioned within a plane above a top surface of the CPA stop 632.

When a user pushes on the user actuation portion 620, the CPA device 612 moves forward within the CPA retention slot 618 in a direction toward the CPA stop 632. The round portion 646 contacts the edge of the hood 654. Due to the curved surface of the round portion 646, the round portion 646 slides under the hood 654, which causes the CPA arm 640 to deflect downward into the CPA retention slot 618 in a plane that is beneath a plane defined by the top surface of the CPA stop 632. Further movement of the CPA device 612 along the positive y-axis direction causes the front edge of the hook end 648 to contact CPA stop 632, which prevents the CPA device 612 from moving any more forward. Thus, the round portion 646 does not enter the arm receiving aperture 652. This provides the user with visual feedback that the CPA device 612 is not within the engaged position. It is noted that in some embodiments the round portion 646 does not get positioned fully under the hood 654. Rather, the hood 654 only engages a sloped portion of the CPA device 612. This provides a return of the CPA device 612 and additional feedback that the CPA device 612 is not engaged.

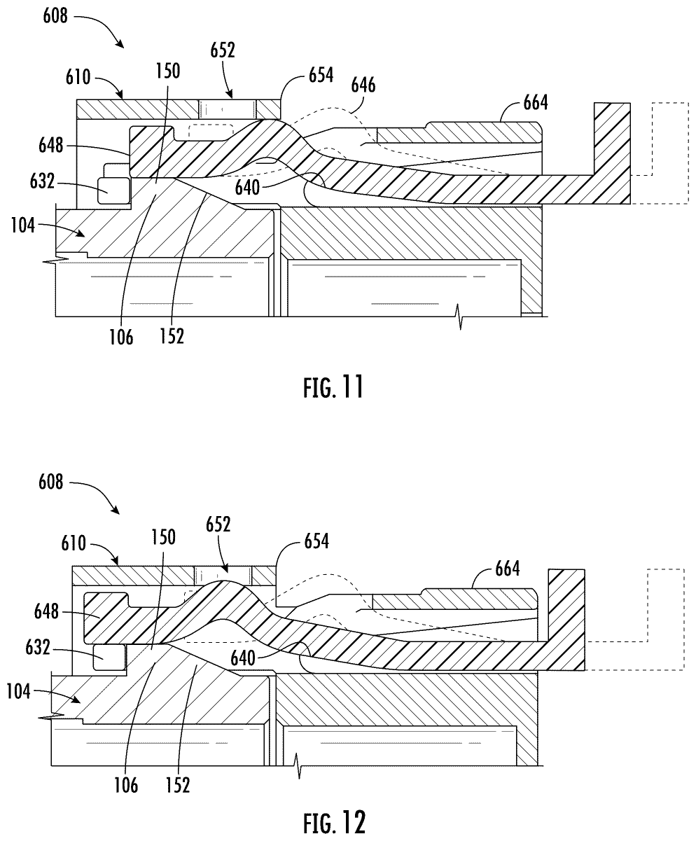

FIG. 11 illustrates a connector assembly 608 assembly properly mated to a receptacle 104. The receptacle latch stop 106 has cleared the CPA stop 132 in this mated state. The dashed lines representing the CPA device 612 show the CPA device 612 prior to it being pushed forward along the positive y-axis by the user. In this state, the round portion 646 of the CPA device 612 is not positioned under the hood 654 and therefore the user is free to unlock the connector assembly 608 from the receptacle 104 by pressing down on the user actuation end 664 of the retention arm 616 to lift the CPA stop 632 so that the user can pull the connector assembly 608 from the receptacle 104. In other words, the CPA device 612 does not inhibit the user from depressing the user actuation end 664 to unlock the connector assembly 608.

The solid lines of the CPA device 612 represent the CPA device 612 being partially pushed forward along the positive y-axis. The round portion 646 contacts the hood 654, which causes the CPA arm 640 to deflect downward. However, the presence of the ramp 152 of the receptacle latch stop 106 presents the hook end 648 from deflecting downward. Therefore, the middle portion of the CPA arm 640 proximate the round portion 646 is deflected downward in the negative z-axis direction. The hood 654 may also get deflected in the positive z-axis direction.

As the user continues to push the CPA device 612 forward, the hook end 648 is then supported by a planar surface 150 of the receptacle latch stop 106, which prevents the hook end 648 of the CPA arm 640 from contacting the vertical surface of the CPA stop 648 (i.e., along the z-axis direction).

FIG. 12 illustrates the CPA device 612 in the fully engaged position. The planar surface 150 of the receptacle latch stop 106 allows the hook end 648 to slide over and onto the horizontal surface (i.e., along the x-axis) of the CPA stop 632. In this manner, the CPA stop 632 does not inhibit the movement of the CPA device 612. When the CPA device 612 is fully inserted into the engaged state, the round portion 646 of the CPA arm 640 is disposed within the arm receiving aperture 652. This provides visual feedback to the user that the CPA device 612 is in the engaged state and the connector assembly 608 is properly mated to the receptacle 104. In some embodiments, the round portion 646 and the arm receiving aperture 652 are sized and shaped such that the round portion 646 snaps into the arm receiving aperture 652 to provide the user with haptic feedback that the CPA device 612 is in the engaged state and the connector assembly 608 is properly mated to the receptacle 104.

The CPA device 612 is also configured to prevent unlocking the connector assembly 608 from the receptacle 104 when in the engaged state. The hook end 648 rests on top of the CPA stop 632. The hook end 648 is shaped such that it is close to or contacts a bottom surface of the hood 654. Therefore, when a user attempts to push down on the user actuation end 664 of the retention arm 616, the portion of the retention arm 616 defining the CPA stop 632 cannot be deflected upward to release the receptacle latch stop 606. To unlock the connector assembly 608 from the receptacle 104, the user pulls back on the user actuation portion 620 of the CPA device to the disengaged state, presses down on the user actuation end 664 of the retention arm 616, and then pulls the connector assembly 608 out of the receptacle 104.

It should now be understood that embodiments of the present disclosure are directed to CPA devices and optical assemblies incorporating the same wherein the CPA devices provide visual and/or haptic feedback that a connector assembly is properly mated to a receptacle. The CPA devices described herein provide a mechanically actuated feature on the connector assembly that will engage the primary latching of the connector assembly in such a way as to prevent it from de-latching. Thus, the CPA devices described herein ensure that a connector assembly is fully latched at its connection point when it is seated with respect to a receptacle and prevents accidental latch release. Further, the CPA devices described herein only actuate into an engaged position when the primary connector latching mechanism is seated. In this way the CPA device provides feedback if the primary latch is not seated and prevents a false positive by seating when the connection is separated. In some embodiments, features of the CPA devices provide visual, audible, and tactile cues that the CPA function has been engaged or disengaged. Non-limiting examples of such features include color contrast between the CPA device and the primary connector assembly parts (e.g., red), a visual difference between when the CPA device is engaged and disengaged, a latch clicking sound when CPA device is engaged and disengaged, and a feedback force requirement to engage and disengage.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

What is claimed is:

1. A connector position assurance (CPA) assembly comprising:
a trigger housing operable to be disposed on a connector housing, the trigger housing comprising:
a retention arm;
a CPA retention slot within a portion of the retention arm;
a CPA stop at a forward end of the CPA retention slot; and
a hood positioned above a portion of the CPA retention slot such that a gap region is present between the retention arm and the hood; and
a CPA device comprising a user actuation portion and a CPA arm extending from the user actuation portion, wherein a portion of the CPA arm is disposed within the CPA retention slot such that:
when the connector housing is not mated to a receptacle, forward motion of the CPA device is prevented by an end of the CPA arm contacting the CPA stop; and
when the connector housing is mated to the receptacle, forward motion of the CPA device is permitted by deflection of the CPA arm into the gap region and above the CPA stop.

2. The CPA assembly of claim 1, wherein the CPA arm comprises a CPA protrusion that is operable to contact an edge of the hood when the CPA device is moved forward relative to the trigger housing.

3. The CPA assembly of claim 1, wherein the retention arm comprises a tapered section to provide for the gap region between the retention arm and the hood.

4. The CPA assembly of claim 1, wherein the retention arm comprises a round portion such that the round portion contacts a surface of the hood to deflect the retention arm downward in a direction away from the hood such that the end of the retention arm contacts the CPA stop when the connector housing is not mated to the receptacle.

5. The CPA assembly of claim 4, wherein the hood comprises an arm receiving aperture, and the round portion of the retention arm is disposed within the arm receiving aperture when the connector housing is inserted into the receptacle and the CPA device is pushed into an engaged state.

6. A connector system comprising:
a connector assembly comprising:
a connector housing;
a connector position assurance (CPA) assembly comprising:
a trigger housing disposed around the connector housing, the trigger housing comprising:
a retention arm;
a CPA retention slot within a portion of the retention arm;
a CPA stop at a forward end of the CPA retention slot; and
a hood positioned above a portion of the CPA retention slot such that a gap region is present between the retention arm and the hood; and
a CPA device comprising a user actuation portion and a CPA arm extending from the user actuation portion, wherein a portion of the CPA arm is disposed within the CPA retention slot; and
a receptacle operable to receive the connector assembly the receptacle comprising a receptacle latch stop, wherein:
when the connector housing is not mated to the receptacle, forward motion of the CPA device is prevented by an end of the CPA arm contacting the CPA stop; and
when the connector housing is mated to the receptacle, forward motion of the CPA device is permitted by deflection of the CPA arm into the gap region and above the CPA stop.

7. The connector system of claim 6, wherein:
the receptacle latch stop comprises a ramp and a wall; and
when the connector housing is inserted into the receptacle, the ramp pushes the CPA arm out of the CPA retention slot such that the CPA arm enters the gap region and such that the CPA arm is pushed over the CPA stop when the CPA device is pressed forward toward the receptacle.

8. The connector system of claim 6, wherein the receptacle latch stop is within the CPA retention slot and contacts the CPA stop when the connector housing is inserted into the receptacle to lock the connector assembly to the receptacle.

9. The connector system of claim 8, wherein the receptacle latch stop is released from the CPA retention slot and the CPA stop when the CPA device is pulled into a disengaged state and an end of the retention arm is pressed downward toward the CPA device.

10. The connector system of claim 6, wherein the CPA arm comprises a CPA protrusion that is operable to contact an edge of the hood when the CPA device is moved forward relative to the trigger housing.

11. The connector system of claim 6, wherein the retention arm comprises a tapered section to provide for the gap region between the retention arm and the hood.

12. The connector system of claim 6, wherein the retention arm comprises a round portion such that the round portion contacts a surface of the hood to deflect the retention arm downward in a direction away from the hood such that the end of the retention arm enters the CPA retention slot and contacts the CPA stop when the connector housing is not mated to the receptacle.

13. The connector system of claim 12, wherein the receptacle latch stop prevents the retention arm from being deflected into the CPA retention slot and from contacting the CPA stop when the connector housing is inserted into the receptacle.

14. The connector system of claim 12, wherein the hood comprises an arm receiving aperture, and the round portion of the retention arm is disposed within the arm receiving aperture when the connector housing is inserted into the receptacle and the CPA device is pushed into an engaged state.

15. An optical assembly comprising:
a cable assembly comprising:
an optical cable comprising at least one optical fiber;
a connector assembly terminating the at least one optical fiber, the connector assembly comprising:
a connector housing;
a connector position assurance (CPA) assembly comprising:
a trigger housing disposed around the connector housing, the trigger housing comprising:
a retention arm;
a CPA retention slot within a portion of the retention arm;
a CPA stop at a forward end of the CPA retention slot; and
a hood positioned above a portion of the CPA retention slot such that a gap region is present between the retention arm and the hood; and
a CPA device comprising a user actuation portion and a CPA arm extending from the user actuation portion, wherein a portion of the CPA arm is disposed within the CPA retention slot; and
a receptacle operable to receive the connector assembly, the receptacle comprising a receptacle latch stop, wherein:
when the connector housing is not mated to the receptacle, forward motion of the CPA device is prevented by an end of the CPA arm contacting the CPA stop; and
when the connector housing is mated to the receptacle, forward motion of the CPA device is permitted by deflection of the CPA arm into the gap region and above the CPA stop.

16. The optical assembly of claim 15, wherein:
the receptacle latch stop comprises a ramp and a wall; and
when the connector housing is inserted into the receptacle, the ramp pushes the CPA arm out of the CPA retention slot such that the CPA arm enters the gap region and such that the CPA arm is pushed over the CPA stop when the CPA device is pressed forward toward the receptacle.

17. The optical assembly of claim 15, wherein the receptacle latch stop is within the CPA retention slot and contacts the CPA stop when the connector housing is inserted into the receptacle to lock the connector assembly to the receptacle.

18. The optical assembly of claim 17, wherein the receptacle latch stop is released from the CPA retention slot and the CPA stop when the CPA device is pulled into a disengaged state and an end of the retention arm is pressed downward toward the CPA device.

19. The optical assembly of claim 15, wherein the CPA arm comprises a CPA protrusion that is operable to contact an edge of the hood when the CPA device is moved forward relative to the trigger housing.

20. The optical assembly of claim 15, wherein the retention arm comprises a tapered section to provide for the gap region between the retention arm and the hood.

21. The optical assembly of claim 15, wherein the retention arm comprises a round portion such that the round portion contacts a surface of the hood to deflect the retention arm downward in a direction away from the hood such that the end of the retention arm enters the CPA retention slot and contacts the CPA stop when the connector housing is not mated to the receptacle.

22. The optical assembly of claim 21, wherein the hood comprises an arm receiving aperture, and the round portion of the retention arm is disposed within the arm receiving aperture when the connector housing is inserted into the receptacle and the CPA device is pushed into an engaged state.

23. The optical assembly of claim 21, wherein the receptacle latch stop prevents the retention arm from being deflected into the CPA retention slot and from contacting the CPA stop when the connector housing is inserted into the receptacle.

24. A method of coupling a connector assembly to a receptacle, wherein the connector assembly comprises a connector housing and a connector position assurance (CPA) assembly having a trigger housing disposed around the connector housing, the trigger housing comprises a retention arm and a CPA retention slot within a portion of the retention arm, and the CPA assembly further comprises a CPA device including a CPA arm disposed within the CPA retention slot of the retention arm, the method comprising:
inserting the connector housing of the connector assembly into the receptacle such that a receptacle latch stop is positioned within the CPA retention slot of the retention arm of the trigger housing, wherein the receptacle latch stop contacts a CPA stop of the retention arm, and a presence of the receptacle latch stop prevents the CPA arm of the CPA device from being present in the CPA retention slot; and
pushing a user actuation portion of the CPA device in a direction toward the receptacle such that a portion of the CPA arm is disposed over the CPA stop to position the CPA device in an engaged state so that a protrusion provides a visual indication that the CPA device is in the engaged state.

25. The method of claim 24, wherein:
the receptacle latch stop comprises a ramp and a wall; and
when the connector housing is inserted into the receptacle, the ramp pushes the CPA arm out of the CPA retention slot such that the CPA arm enters a gap region and such that the CPA arm is pushed over the CPA stop when the CPA device is pressed forward toward the receptacle.

26. The method of claim 24, wherein:
the trigger housing comprises a hood; and
the protrusion comprises a round portion such that the round portion contacts a surface of the hood to deflect the retention arm downward in a direction away from the hood such that the end of the retention arm enters the CPA retention slot and contacts the CPA stop when the connector housing is not mated to the receptacle.

27. The method of claim 26, wherein the hood comprises an arm receiving aperture, and the round portion of the retention arm is disposed within the arm receiving aperture when the connector housing is inserted into the receptacle and the CPA device is pushed into the engaged state.
